(19) United States
(12) Patent Application Publication
(10) Pub. No.: US 2012/0221509 A1
(43) Pub. Date: Aug. 30, 2012

(54) DETERMINING A DATA MAPPING RELATIONSHIP BETWEEN DATABASE TABLES

(75) Inventors: XUE FENG GAO, Beijing (CN); Lin Ju, Beijing (CN); Hua Fang Tan, Beijing (CN); Jun Zhu, Beijing (CN)

(73) Assignee: INTERNATIONAL BUSINESS MACHINES CORPORATION, Armonk, NY (US)

(21) Appl. No.: 13/402,378

(22) Filed: Feb. 22, 2012

(30) Foreign Application Priority Data
Feb. 28, 2011 (CN) 201110047151.9

(51) Int. Cl. G06F 7/00; G06F 17/30

(52) U.S. Cl. 707/602; 707/600; 707/E17.044

(57) ABSTRACT

A method and apparatus for determining a data mapping relationship between a source database table and a target database table are included. The method includes obtaining attribute values of an attribute other than a primary key and corresponding primary key value sets from plural rows of data in a source database table, and obtaining attribute values of a specific attribute other than a corresponding primary key and corresponding primary key value sets from plural rows of data in the target database table. A determination is made as to whether the attribute of the source database table and the specific attribute of the target database table have a potential data mapping relationship. If the determination is affirmative, a data mapping relationship is determined therebetween.

### FIELD OF THE INVENTION

The present invention relates to the data processing technology, and more particularly, to a method and apparatus for determining a data mapping relationship between a source database table and a target database table, and a method and apparatus for validating data.

### BACKGROUND

Business intelligence (BI for short) has been a hot technical topic for years, and more and more enterprises use business intelligence technology to provide decision support. Business intelligence refers to a computer-based technology for discovering, collecting and analyzing business data, like sales, costs and incomes, of enterprises. Business intelligence technology usually extracts data from data sources like business systems, such as ERP (Enterprise Resource Planning), CRM (Customer Relationship Management), of an enterprise, as well as an external environment where the enterprise is located, and injects the data into a data warehouse after performing proper transformation on the data, through an ETL (Extract-Transform-Load) process; then, generates a data report for decision support through a technique like OLAP (On-Line Analytical Processing). FIG. 1 shows a schematic diagram of business intelligence technology. As shown, data from data sources like ERP, CRM and other business system databases are injected into the data warehouse through an ETL process, and various data reports for decision support can be generated according to the data in the data warehouse through an OLAP process.

The accuracy of data in the data warehouse is of vital importance to the provision of correct decision support. In the current BI solution, the following three types of data errors often occur: first, dirty data will appear in the data warehouse, where dirty data is not generated from proper transformation of the data in the data source, but mistakenly generated during the ETL process; second, incorrect filter logic is applied to the data in the data source to filter out data that should not be filtered out, so that the data warehouse does not have data that should have been present; third, the ETL development is not in conformity with the design specification, and incorrect data transformation is applied during the ETL process, so that the mapping relationships between data in the data warehouse and data in the data source are not correct.

In order to find out and correct data errors in the BI solution, the data in the BI solution needs to be validated. FIG. 2 shows an existing sample-based validation method. As shown, the method requires that the tester obtains random sample target data from a target database (i.e., a data warehouse), understands the business meaning of the target data, and generates a query to a source database (i.e., a business system database as the data source) according to the business meaning, acquires the source data by executing the query against the source database, and compares the source data with the target data to find data errors.

Such a data validation method has the following disadvantages:

It is highly dependent on the tester to understand the business meanings of the target data and the source data, and such a requirement is very hard to achieve for many testers;

This data validation method is performed manually, not automatically, thus is time-consuming, laborious, and inefficient;

Since the data in the target database and the source database are usually enormous, it is usually impossible to validate all the data;

Since only part of the data in the target database and the source database can be validated, it may be impossible to find out some errors in the BI solution.

### SUMMARY

To overcome the disadvantages in the current data validation method, a method and apparatus for validating data of the present invention are provided.

According to an aspect of the present invention, there is provided a method for determining a data mapping relationship between a source database table and a target database table, comprising: obtaining attribute values of at least one other attribute than a primary key and their corresponding primary key value sets from plural rows of data in at least one source database table, and obtaining attribute values of a specific attribute other than the corresponding primary key and their corresponding primary key value sets from plural rows of data of a target database table; determining whether the at least one other attribute of the at least one source database table and the specific attribute of the target database table have a potential data mapping relationship therebetween; if it is determined that the at least one other attribute of the at least one source database table and the specific attribute of the target database table have a potential data mapping relationship therebetween, determining a data mapping relationship between the at least one other attribute of the at least one source database table and the specific attribute of the target database table.

According to another aspect of the present invention, there is provided a method for validating data, comprising: the steps in the above method for determining a data mapping relationship between a source database table and a target database table; and according to the determined data mapping relationship, validating attribute values of at least one other attribute of the at least one source database table and/or attribute values of the specific attribute of the target database table.

According to yet another aspect of the present invention, there is provided an apparatus for determining a data mapping relationship between a source database table and a target database table, comprising: an attribute value profiling module configured to obtain attribute values of at least one other attribute than a primary key and their corresponding primary key value sets from plural rows of data in a source database table, and obtain attribute values of a specific attribute other than a corresponding primary keys and their corresponding primary key value sets from plural rows of data in a target database table; a potential data mapping relationship determining module configured to determine whether the at least one other attribute of the at least one source database table and the specific attribute of the target database table have a potential data mapping relationship therebetween; a database mapping relationship determining module configured to, if the at least other attribute of the at least one source database and the specific attribute of the target database table have a potential data mapping relationship therebetween, determine a data mapping relationship between the at least one other attribute of the at least one source database table and the specific attribute of the target database table.

According to a further aspect of the present invention, there is provided an apparatus for validating data, comprising: the modules in the above apparatus for determining a data mapping relationship between a source database table and a target database table; and a validation module configured to validate attribute values of the at least one other attribute of the at least one source database table and/or attribute values of the specific attribute of the target database table according to the determined data mapping relationship.

The advantages of the technical solution of the present invention include at least one of the following:

The technical solution of the present invention automatically derives the data mapping relationships between the source data and the target data from the source data and the target data per se, and does not require the tester to manually acquire the data mapping relationships between the source database and the target database from the design specification, and thus it is suitable for the case where the design specification is not easy to obtain, and saves the time and cost for the tester to read and understand the complex design specification, and does not require the tester to understand the business meanings of the target data and the source data;

Since the technical solution of the present invention automatically obtains data in the source database and in the target database, derives the data mapping relationships between the source data and the target data, and validates the source data and the target data according to the derived data mapping relationships, the technical solution of the present invention can easily realize the validation of all the data in the target database and the source database, so as to realize a complete test coverage and find out various data errors in the target database and the source database, like dirty data, wrong filter logics and wrong data transformation.

### BRIEF DESCRIPTION OF DRAWINGS

The appended claims set forth the inventive features which are considered characteristic of the present invention. However, the invention itself and its preferred modes, objectives, features and advantages will be better understood by referring to the detailed description of exemplary embodiments when read in conjunction with the attached drawings, in which:

FIG. 1 shows a schematic diagram of the business intelligence technology;

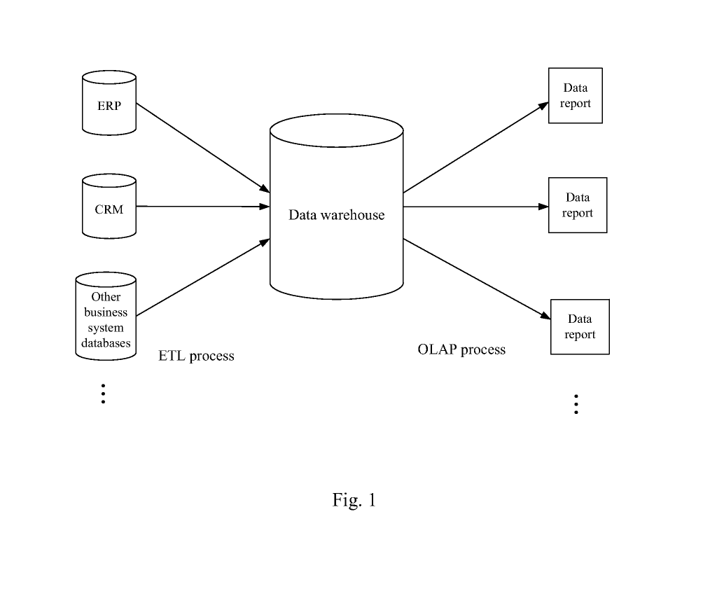

FIG. 2 shows an existing sample-based validation method;

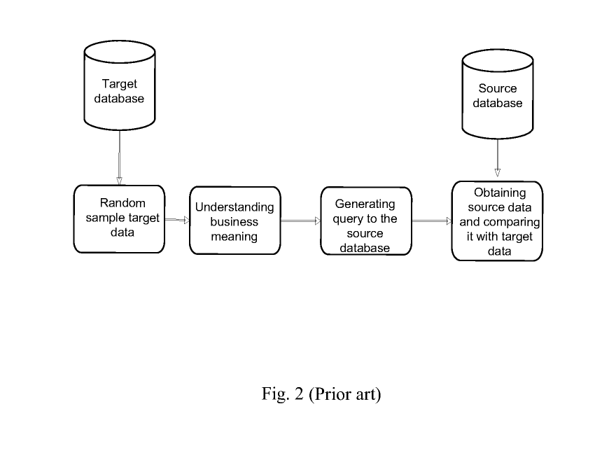

FIG. 3 shows a method for determining a data mapping relationship between a source database table and a target database table according to an embodiment of the present invention; and

FIG. 4 shows an apparatus for determining a data mapping relationship between a source database table and a target database table according to an embodiment of the present invention.

### DETAILED DESCRIPTION

Embodiments of the present invention will now be described with reference to the accompanying drawings. In the following description, numerous details are described to enable the present invention to be fully understood. However, it is obvious to those skilled in the art that the realization of the present invention can exclude some of these details. In addition, it should be appreciated that the present invention is not limited to the described specific embodiments. On the contrary, it is contemplated to implement the present invention by using any combination of the following features and elements, no matter whether they involve different embodiments or not. Therefore, the following aspects, features, embodiments and advantages are only illustrative, rather than elements or limitations of the appended claims, unless explicitly stated otherwise in the claims.

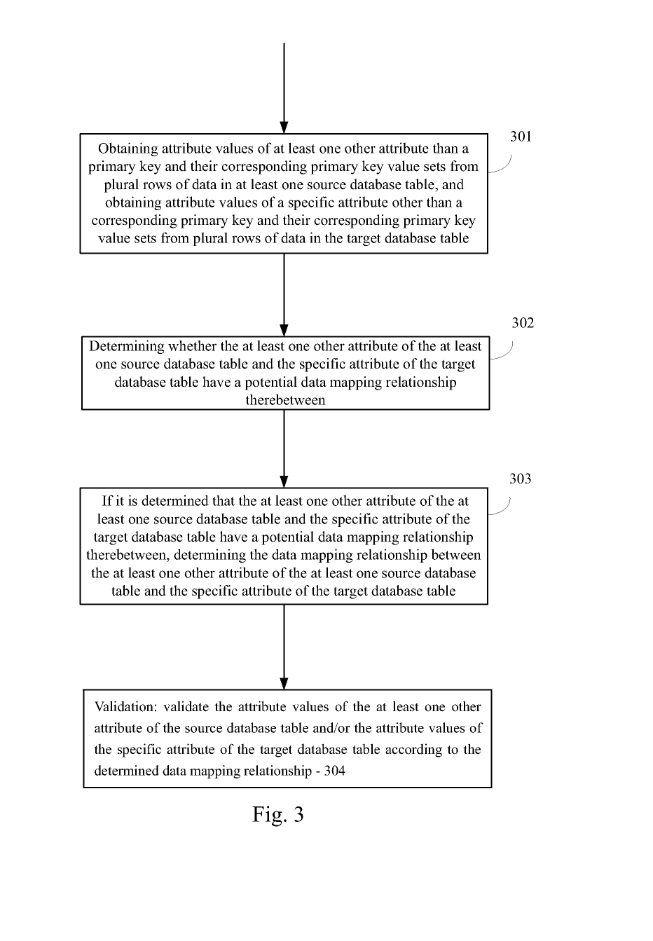

Now referring to FIG. 3, a method for determining a data mapping relationship between a source database table and a target database table according to an embodiment of the present invention is illustratively shown. As shown, the method comprises the following steps:

In step 301, profile the attribute values of at least one other attribute other than a primary key of at least one source database table according to plural rows of data in the at least one source database table, and profile the attribute values of a specific attribute other than a corresponding primary key of a target database table according to plural rows of data in the target database table; that is to say, obtain attribute values of the at least one other attribute other than the primary key and their corresponding primary key value sets from the plural rows of data in the at least one source database table, and obtain attribute values of the specific attribute other than the corresponding primary key and their corresponding primary key value sets from the plural rows of data of the target database table. Specifically, in this step, for each other attribute in the at least one other attribute other than the primary key in the at least one source database table, obtain all the different attribute values of the other attributes from the plural rows of data in the at least one source database table, and obtain a primary key value set of the primary key corresponding to each different attribute value of the other attribute; similarly, for the specific attribute other than the corresponding primary key of the target database table, obtain all the different attribute values of the specific attribute from the plural rows of data in the target database table, and obtain a primary key value set of the corresponding primary key corresponding to each different attribute value of the specific attribute.

According to an embodiment of the present invention, the target database table is a database table in a data warehouse in a business intelligence solution, and the at least one source database table is a database table in a business system database used as the data source of the data warehouse. Of course, this is not a limitation to the present invention. In fact, the method of the present invention is suitable for any source database table and target database table having data source or data transformation relationships in any applications.

As known by those skilled in the art, a primary key refers to an attribute (i.e., column) set that can uniquely determine a row in a database table; that is to say, in the database table, there are not two or more rows in which the values of the one or more attributes constituting of the primary key are the same. The primary key of the at least one source database table and the corresponding primary key of the target database table have a corresponding relationship therebetween, and the two may either be identical or be different. When the primary key of the at least one source database table and the primary key of the target database table are different, since the corresponding relationship between the primary keys of the two may be obtained, the primary key values of the two can be converted into the same primary key values, e.g., by converting the primary key values of the source database table into the corresponding primary key values of the target database table, or by converting the corresponding primary key values of the target database table into the primary key values of the source database table, or by converting the primary key values of the source database table and the corresponding primary key values of the target database table into common primary key values, so as to facilitate subsequent operations.

The at least one other attribute than the primary key of the at least one source database table can be any one or more other attributes selected by the user than the primary key of the at least one source database table, or be all the other attributes than the primary key of the at least one source database table; the specific attribute other than the corresponding primary key of the target database table may be any other attribute selected by the user than the corresponding primary key of the target database table.

For example, all the different attribute values of the attribute, “price”, and their corresponding primary key value sets obtained from plural rows of data of a source database table can be as shown by the following table:

TABLE 1
Source attribute “price”

| Attribute value | Primary key value set |
|---|---|
| 1 | 001, 004 |
| 2 | 002 |
| 3 | 003 |

All the different attribute values of the attribute, “number”, and their corresponding primary key value sets obtained from the plural rows of data of the source database table can be as shown by the following table:

TABLE 2
Source attribute “number”

| attribute value | primary key value set |
|---|---|
| 1 | 001 |
| 2 | 003 |
| 3 | 002, 004 |

All the different attribute values of the attribute, “cost”, and their corresponding primary key value sets obtained from plural rows of data of a source database table can be as shown by the following table:

TABLE 3
Target attribute “cost”

| attribute value | primary key value set |
|---|---|
| 1 | 001 |
| 3 | 004 |
| 6 | 002, 003 |

According to an embodiment of the present invention, step 301 may be executed by the apparatus of the present invention automatically.

According to an embodiment of the present invention, the method further comprises an optional step prior to step 301. In the optional step, determine the primary key of the at least one source database table and the corresponding primary key of the target database table. Preferably, the primary key of the at least one source database table and the corresponding primary key of the target database table may be determined by the user. The user may determine the primary key of the at least one source database table and the corresponding primary key of the target database table through reading the BI design specification documents, etc. Of course, it may also be contemplated to determine the primary key of the at least one source database and the corresponding primary key of the target database table from BI design specification documents in an automatic manner. The corresponding primary key of the target database table refers to the primary key of the target database table converted from the primary key of the at least one source database table through a data transformation process like ETL.

According to an embodiment of the present invention, the method further comprises another optional step before step 301. In the other optional step, acquire plural rows of data in the at least one source database table and plural rows of data in the target database table. As known by those skilled in the art, the plural rows of data in the at least one source database table and the plural rows of data in the target database table can be acquired by executing corresponding query statements against the at least one source database table and the target database table. In an embodiment of the present invention, all the rows of data in the at least one source database table and all the rows of data in the target database table can be acquired. Of course, it may also be contemplated to acquire the data of part of the rows satisfying certain criterion (e.g., within a specified time limit) in the at least one source database table and the data of part of the rows satisfying certain criterion in the target database table. According to an embodiment of the present invention, the other optional step can be automatically executed by the apparatus of the present invention.

In step 302, determine whether there is a potential data mapping relationship between the at least one other attribute of the at least one source database table and the specific attribute of the target database table.

According to an embodiment of the present invention, said determining whether there is a potential data mapping relationship between the at least one other attribute of the at least one source database table and the specific attribute of the target database table is performed by comparing the primary key value sets corresponding to the attribute values of the at least one other attribute of the at least one source database table with the corresponding primary key value sets corresponding to the attribute values of the specific attribute of the target database table.

According to a further embodiment of the present invention, step 302 includes the following sub-steps:

Sub-step 302-1: determine whether the corresponding primary key value sets corresponding to the attribute values of the specific attribute of the target database table are correspondent with the primary key value sets corresponding to the attribute values of one other attribute of the source database table. When the primary key values of the source database table are the same as the corresponding primary key values of the target database table, it can be determined directly whether the corresponding primary key value sets corresponding to the attribute values of the specific attribute of the target database table are equal to the primary key value sets corresponding to the attribute values of the one other attribute of the source database table.

Sub-step 302-2: in response to the determination of yes, determine whether there is a potential data mapping relationship between the one other attribute of the source database table and the specific attribute of the target database table.

That is to say, for the corresponding primary key value set corresponding to each attribute value of the specific attribute of the target database table, it is determined whether the primary key value set corresponding to an attribute value of some other attribute of the source database table is correspondent with or equal to the corresponding primary key value set; and for the primary key value set corresponding to each attribute value of some other attribute of the source database table, it is determined whether the corresponding primary key value set corresponding to some attribute value of the specific attribute of the target database table is correspondent with or equal to the primary key value set. If the above determination is yes, it can be determined that there is a potential data mapping relationship between the specific attribute of the target database table and the other attribute of the source database table.

For example, assume that all the different attribute values of the attribute “price” and their corresponding primary key value sets obtained from plural rows of data of a target database table are as shown by the following table:

TABLE 4
Target attribute “price”

| Attribute value | Primary key value set |
|---|---|
| 10 | 001, 004 |
| 20 | 002 |
| 30 | 003 |

It can be known by comparing table 1 and table 4 that the primary key value sets corresponding to the attribute values of the source attribute “price”, {001, 004}, {002}, {003} are equal to the primary key value sets corresponding to the attribute values of the target attribute “price”, {001, 004}, {002}, {003}. Therefore, it can be determined that there is a potential data mapping relationship between the source attribute “price” and the target attribute “price”.

According to a further embodiment of the present invention, step 302 includes the following sub-steps:

Sub-step 302-3: determine whether the corresponding primary key value sets corresponding to the attribute values of the specific attribute of the target database table are correspondent with the intersections of the corresponding primary key value sets corresponding to the attribute values of plural other attributes of the source database table respectively. When the primary key values of the source database table and the corresponding primary key values of the target database table are the same, it can be determined directly whether the corresponding primary key value sets corresponding to the attribute values of the specific attribute of the target database table are equal to the intersections of the primary key value sets corresponding to the attribute values of plural other attributes of the source database table.

Sub-step 302-4: in response to the determination of yes, determine that there is a potential data mapping relationship between the plural other attributes of the source database table and the specific attribute of the target database table.

That is to say, for the corresponding primary key value set corresponding to each attribute value of the specific attribute of the target database table, it is determined whether the intersection of the primary key value sets corresponding to the attribute values of two or more other attributes of the source database table respectively is correspondent with or equal to the corresponding primary key value set. If the determination is yes, it can be determined that there is a potential data mapping relationship between the specific attribute of the target database table and the two or more other attributes of the source database table.

For example, it can be known from the above table 1, table 2 and table 3 that the corresponding primary key value sets corresponding to the attribute values of the target attribute “cost” and the primary key value sets corresponding to the attribute values of the source attribute “price” and the source attribute “number” have the following relationships therebetween:

{001,004}∩{001}={001}

{001,004}∩{002,004}={004}

({002}∪{003})∩({002,004}∪{003})={002,003}

That is to say, the corresponding primary key value set corresponding to each attribute of the target attributes “cost” is equal to the intersection of the primary key value set corresponding to a certain attribute value of the source attribute “price” (or the union of the primary key value sets corresponding to plural attribute values respectively), and the primary key value set corresponding to a certain attribute value of the source attribute “number” (or the union of the primary key value sets corresponding to plural attribute values respectively). Thus, it can be determined that there is a potential data mapping relationship between the target attributes “cost”, and the source attributes “price” and “number”.

It can also be known from the above examples that when the corresponding primary key value set corresponding to an attribute value of the target attribute only includes one primary key, a primary key value set including the primary key value (or the corresponding primary key value) can be directly looked for from the primary key value sets corresponding to the attribute values of each source attribute in plural source attributes, and it can be determined whether the corresponding primary key value set of the target attribute is equal to or correspondent with the intersection of the found primary key value sets of the source attributes. When the corresponding primary key value set corresponding to a certain attribute value of the target attribute includes two and more primary key values, either for each primary key value therein, the primary key value set including the primary key value (or the corresponding primary key value) can be looked for from the primary key value sets corresponding to the attribute values of each source attribute in the plural source attributes, and it can be determined whether the primary key value of the target attribute is equal to or correspondent with the intersection of the found primary key value sets of the source attributes; or, the union of the primary key value sets including the primary key values (or the corresponding primary key values) of the target attribute can be first obtained from the primary key value sets corresponding to the attribute values of each source attribute of the plural source attributes, and then it can be determined whether the intersection of the obtained unions of the source attributes is equal to or correspondent with the corresponding primary key value set corresponding to the attribute value of the target attribute.

For example, in the above example, for the corresponding primary key value set {001} corresponding to the attribute value “1” of the target attribute “cost”, the primary key value set {001, 004} including the attribute value “001” and corresponding to the attribute value “1” of the source attribute “price” as well as the primary key value set {001} including the attribute value “001” and corresponding to the attribute value “1” of the source attribute “number” can be found, and it can be determined that the corresponding primary key value set {001} of the target attribute is equal to the intersection of the primary key value sets {001, 004} and {001} of the source attribute.

For the corresponding primary value key set {004} corresponding to the attribute value “3” of the target attribute “cost”, the primary key value set {001, 004} including the attribute value “004” and corresponding to the attribute value “1” of the source attribute “price” as well as the primary key value set {002,004} including the attribute value “004” and corresponding to the attribute value “3” of the source attribute “number” can be found, and it can be determined that the corresponding primary key value set {004} of the target attribute is equal to the intersection of the primary key value sets {001, 004} and {002, 004} of the source attributes.

For the corresponding primary key value set {002, 003} corresponding to the attribute value “6” of the target attribute “cost”, the primary key value set {002} including the attribute value “002” and corresponding to the attribute value “2” of the source attribute “price” as well as the primary key value set {002, 004} including the attribute value “002” and corresponding to the attribute value “3” of the source attribute “number” can be found, and it can be determined that the corresponding primary key value “002” (or the set {002} only including this primary key value) of the target attribute is equal to the intersection of the primary key value sets {002} and {002, 004} of the source attribute; and further the primary key value set {003} including the attribute value “003” and corresponding to the attribute value “3” of the source attribute “cost” and as well as the primary key value set {003} including the attribute value “003” and corresponding to the attribute value “2” of the source attribute “number” can be found, and it can be determined that the corresponding primary key value “003” (or the set {003} only including this primary key value) of the target attribute is equal to the intersection of the primary key value sets {003} and {003} of the source attribute.

Alternatively, for the corresponding primary key value set {002, 003} corresponding to the attribute value “6” of the target attribute “cost”, the union {002, 003} of the primary key value set {002} including the attribute value “002” or “003” and corresponding to the attribute value “2” of the source attribute “price” and the primary key value set {003} including the attribute value “002” or “003” and corresponding to the attribute value “3” of the source attribute “price”, as well as the union {003, 002, 004} of the primary key value set {003} including the attribute value “002” or “003” and corresponding to the attribute value “2” of the source attribute “number” and the primary key value set {002, 004} including the attribute value “002” or “003” and corresponding to the attribute value “3” of the source attribute “number”, can be obtained. It can be determined that the corresponding primary key value set {002, 003} of the target attribute is equal to the intersection of the obtained unions {002, 003} and {003, 002, 004} of the primary key value sets of the source attributes.

According to another embodiment of the present invention, step 302 includes all of the above sub-steps 302-1, 302-2, 302-3 and 302-4.

According to some embodiments of the present invention, determining whether the corresponding primary key value sets corresponding to the attribute values of the specific attribute of the target database table are equal to or correspondent with the primary key value sets corresponding to the attribute values of one other attribute of the source database table in the above sub-step 302-1 is performed based on the corresponding primary key value sets corresponding to attribute values exceeding a specified threshold percentage among all the attribute values of the specific attribute of the target database table as well as the primary key value sets corresponding to attribute values exceeding a specific threshold percentage among all the attribute values of the one other attribute of the source database table; determining whether the corresponding primary key value sets corresponding to the attribute values of the specific attribute of the target database table are equal to or correspondent with the intersections of the primary key value sets corresponding to the attribute values of plural other attributes of the source database table respectively in the above sub-step 302-3 is performed based on the corresponding primary key value sets corresponding to attribute values exceeding a specified threshold percentage among all the attribute values of the specific attribute of the target database table as well as the primary key value sets corresponding to attribute values exceeding a specified threshold percentage among all the attribute values of the plural other attributes of the source database table. That is to say, it is not needed to determine that the corresponding primary key value set corresponding to each attribute value of the specific attribute of the target database table is equal to or correspondent with the primary key value set corresponding to each corresponding attribute value of the at least one other attribute of the source database table, and it is only needed to determine that the corresponding primary key value sets corresponding to attribute values exceeding a specified threshold percentage (e.g., 98%) of the specific attribute of the target database table are equal to or correspondent with the primary key value sets corresponding to attribute values exceeding a specified threshold percentage (e.g., 98%) of the at least one other attribute of the source database table, so as to be able to determine that the at least one other attribute of the source database table and the specific attribute of the target database table have a potential data mapping relationship therebetween.

According to some other embodiments of the present invention, determining whether the corresponding primary key value sets corresponding to the attribute values of the specific attribute of the target database table are equal to or correspondent with the primary key value sets corresponding to the attribute values of the at least one other attribute of the source database table is performed based on the corresponding primary key value corresponding to each attribute value in all the attribute values of the specific attribute of the target database table as well as the primary key value set corresponding to each corresponding attribute value in all the attribute values of the at least one other attribute of the source database table.

According to an embodiment of the present invention, step 302 can be performed automatically by the apparatus of the present invention.

In step 303, if it is determined that the at least one other attribute of the at least one source database table and the specific attribute of the target database table have a potential data mapping relationship therebetween, determine the data mapping relationship between the at least one other attribute of the at least one source database table and the specific attribute of the target database table. When it is determined that the at least one other attribute of the source database table and the specific attribute of the target database table do not have a potential data mapping relationship therebetween in step 302, the above steps 301 and 302 can be performed again for other specific attributes in the target database table.

According to an embodiment of the present invention, step 303 includes the following sub-steps:

Sub-step 303-1: according to the corresponding relationships between the primary key value sets corresponding to the attribute values of the one or more other attributes of the source database table and the corresponding primary key value sets corresponding to the attribute values of the specific attribute of the target database table, establish the corresponding relationships between the attribute values of the one or more other attributes of the source database table and the attribute values of the specific attribute of the target database table.

Specifically, for the case where, by determining that the corresponding primary key value sets corresponding to the attribute values of the specific attribute of the target database table are equal to or correspondent with the primary key value sets corresponding to corresponding attribute values of the other attribute of the source database table, it is determined that there is a potential data mapping relationship between the other attribute of the source database table and the specific attribute of the target database table in step 302. The corresponding relationship between each attribute value of the specific attribute of the target database table and a certain attribute value of the other attribute of the source database table can be established according to the equality or corresponding relationship between the corresponding primary key value set corresponding to each attribute value of the specific attribute of the target database table and the primary key value set corresponding to a certain attribute value of the other attribute of the source database table.

For example, according to the equality relationship between the primary key value set corresponding to each of the attribute values of the attribute “price” of the target database table as shown in the above table 4 and the primary key value set corresponding to each of the attribute values of the attribute “price” of the source database table as shown in the above table 1, the corresponding relationship between the attribute values of the attribute “price” of the source database table and the attribute values of the attribute “price” of the target database table can be established, which corresponding relationship can be shown by the following table:

TABLE 5
Corresponding relationship between the attribute values of the source
attribute “price” and the attribute values of the target attribute “price”

| attribute values of the source | attribute values of the target |
|---|---|
| attribute “price” | attribute “price” |
| 1 | 10 |
| 2 | 20 |
| 3 | 30 |

Whereas, for the case where, by determining that the corresponding primary key value sets corresponding to the attribute values of the specific attribute of the target database table are equal to or correspondent with the intersections of the primary key value sets corresponding to the attribute values of plural other attributes of the source database table respectively, it is determined that the plural other attributes of the source database table and the specific attribute of the target database table have the potential data mapping relationship therebetween in step 302, the corresponding relationship between the respective attribute values of the plural other attributes of the source database table and attribute values of the specific attribute of the target database table can be established according to the equality or corresponding relationship between the corresponding primary key value set corresponding to each attribute value of the specific attribute of the target database table and the intersection of the primary key value sets corresponding to the attribute values of the plural other attributes of the source database table respectively.

For example, according to the equality relationships between the primary key value sets corresponding to the attribute values of the attribute “price” of the source database table as shown in the above table 1 and the intersection of the primary key value sets corresponding to the attribute values of the attribute “number” of the source database table as shown in the above table 2 and the primary key value sets corresponding to the attribute values of the attribute “cost” of the source database table as shown in the above table 3, the corresponding relationships between the attribute values of the attributes “price” and “number” of the source database table and the attribute values of the attribute “cost” of the target database table can be established, which corresponding relationships can be shown by the following table:

TABLE 6
Corresponding relationships between the attribute values of the source
attributes “price” and “number” and the attribute values of the target
attribute “cost”

| | Attribute values of the | |
|---|---|---|
| Attribute values of the | source attribute | Attribute values of the |
| source attribute “price” | “number” | target attribute “cost” |
| 1 | 1 | 1 |
| 1 | 3 | 3 |
| 2 | 3 | 6 |
| 3 | 2 | 6 |

Sub-step 303-2: according to the established corresponding relationships between the attribute values of the one or more other attributes of the source database table and the attribute values of the specific attribute of the target database table, determine the data mapping relationship between the one or more other attributes of the source database table and the specific attribute of the target database table, i.e., the concrete data mapping relationship between the at least one other attribute of the source database table and the specific attribute of the target database table.

According to an embodiment of the present invention, the sub-step 303-2 can be performed in the following manner: the apparatus of the present invention presents the corresponding relationships between the attribute values of the at least one other attribute of the source database table and the attribute values of the specific attributes of the target database table established in the above sub-step 303-1 to the user, and the user manually determines the specific data mapping relationship between the at least one other attribute of the source database table and the specific attribute of the target database table. For example, according to the corresponding relationships between the attribute values of the source attribute “cost” and the attribute values of the target attribute “cost” shown in table 5, the user can easily determine that the source attribute “price” and the target attribute “price” have the following concrete data mapping relationship:

source attribute “price”*10=target attribute “price”;

For further example, according to the corresponding relationships between the attribute values of the source attributes “price” and “number” and the attribute values of the target attribute “cost” shown in table 6, the user can easily determine that the source attributes “price” and “number” and the target attribute “cost” have the following concrete data mapping relationship:

source attribute “price”*source attribute “number”=target attribute “cost”

According to another embodiment of the present invention, sub-step 303-2 can be performed by the apparatus of the present invention automatically. The apparatus of the present invention may perform each operation in a set of common unary or multiple mathematic operations and data transformation operations on each attribute value of the at least one other attribute of the source database table, and determine whether the operation result is consistent with the corresponding attribute value of the specific attribute of the target database table; when it is determined that the result of a specific mathematic operation or data transformation operation performed on each attribute value of the at least one other attribute of the source database table is consistent with the corresponding attribute value of the specific attribute of the target database table, it can be determined that the at least one other attribute of the source database table and the specific attribute of the target database table have the specific mathematic operation or data transformation relationship therebetween. The set of common mathematic operations and data transformation operations can include operations such as fixed coefficient, addition, subtraction, multiplication and division, etc.

According to some embodiments of the present invention, determining a data mapping relationship between the one or more other attributes of the source database table and the specific attribute of the target database table in the above sub-step 303-2 is performed based on the established corresponding relationships between attribute values exceeding a specified threshold percentage among all the attribute values of the one or more other attributes of the source database table and corresponding attribute values exceeding a specified percentage among all the attribute values of the specific attribute of the target database table. That is to say, it is not needed for each attribute value of the one or more other attributes of the source database table and each corresponding attribute value of the specific attribute of the target database table to have the determined specific data mapping relationship, and it is only needed that attribute values exceeding a specified threshold percentage (e.g., 98%) of the one or more other attributes of the source database table and corresponding attribute values exceeding a specified threshold percentage (e.g., 98%) of the specific attribute of the target database table have the determined specific data mapping relationship.

According to some other embodiments of the present invention, determining a data mapping relationship between the one or more other attributes of the source database table and the specific attribute of the target database table in the above sub-step 303-2 is performed based on the corresponding relationship between each attribute value of the one or more other attributes of the source database table and each corresponding attribute value of the specific attribute of the target database table.

In the above embodiments, determining whether the at least one other attribute of the at least one source database table and the specific attribute of the target database table have a potential data mapping relationship therebetween in step 302 is performed by comparing the primary key value sets corresponding to the attribute values of the at least one other attribute of the at least one source database table and the corresponding primary key value sets corresponding to the attribute values of the specific attribute of the target database table; and determining a data mapping relationship between the at least one other attribute of the at least one source database table and the specific attribute of the target database in step 303 is performed according to the attribute values of the at least one other attribute corresponding to the primary key value sets of the at least one source database and the attribute values of the specific attributes corresponding to the corresponding primary key value sets of the target database table. However, this is not limitation to the present invention. In some other embodiments of the present invention, if a design specification including the data transformation relationships between the source database table and the target database table is known, then it can be determined directly whether the at least one other attribute of the at least one source database table and the specific attribute of the target database table have a potential data mapping relationship therebetween according to the design specification, and the data mapping relationship between the at least one other attribute of the at least one source database table and the specific attribute of the target database table can be determined.

Above is described a method for determining a data mapping relationship between a source database table and a target database table according to embodiments of the present invention by referring to the accompanying drawings. It should be pointed out that the above description is only exemplary, not a limitation to the present invention. In other embodiments of the present invention, the method may have more, less or different steps, and the relationships like those of order and inclusion between the steps may be different from that is described and illustrated.

In another aspect of the present invention, there is provided a method for validating data. According to an embodiment of the present invention, the method for validating data comprises the steps in the above method for determining a data mapping relationship between a source database table and a target data base table according to embodiments of the present invention, and further comprises the following additional step in block 304:

An additional step in block 304: validate the attribute values of the at least one other attribute of the source database table and/or the attribute values of the specific attribute of the target database table according to the determined data mapping relationship.

According to an embodiment of the present invention, the additional step comprises any one or more of the following additional sub-steps:

Additional sub-step 1 (304-1): determine whether the determined data mapping relationship complies with a design specification by comparing the determined data mapping relationship with the design specification including the data transformation relationship between the source database table and the target database table. If the determined data mapping relationship complies with the design specification, it is determined that the determined data mapping relationship is correct; if the determined data mapping relationship does not comply with the design specification, it is determined that the determined data mapping relationship is wrong, and the validation fails. The design specification refers to a design specification of, for example, a BI solution, in which is included specification on how to transform data in a source database such as a business system database into data in a target database such as a data warehouse.

According to an embodiment of the present invention, the determined data mapping relationship can be presented to the user by the apparatus of the present invention, and the user can manually determine whether the determined data mapping relationship complies with the design specification. Of course, it may also be contemplated to determine whether the determined data mapping relationship complies with the design specification by the apparatus of the present invention automatically.

Additional sub-step 2 (304-2): determine whether a specific attribute value of the at least one other attribute of the at least one source database table and a corresponding attribute value of the specific attribute of the target database table comply with the determined data mapping relationship. If the specific attribute value of the at least one other attribute of the at least one source database table and the corresponding attribute value of the specific attribute of the target database table comply with the determined data mapping relationship, then it can be determined that the data of the specific attribute value of the at least one other attribute of the at least one source database table and the corresponding attribute value of the specific attribute of the target database are correct; if the specific attribute value of the at least one other attribute of the at least one source database table and the corresponding attribute value of the specific attribute of the target database table do not comply with the determined data mapping relationship, then it may be determined that the specific value of the at least one other attribute of the at least one source database table and/or the corresponding specific value of the specific attribute of the target database table have a data error.

For the case where the determining in the above sub-steps 302-1 and 302-3 are performed based on the corresponding primary key value sets corresponding to attribute values exceeding a specified threshold percentage among all the attribute values of the specific attribute of the target database table as well as the primary key value sets corresponding to attribute values exceeding a specified threshold percentage among all the attribute values of the one or more other attributes of the source database table, and/or the case where the determining in the above sub-step 303-2 is performed based on the corresponding relationships between attribute values exceeding a specified threshold percentage among all the attribute values of the at least one other attribute of the source database table and corresponding attribute values exceeding a specified threshold percentage among all the attribute values of the specific attribute of the target database table, in the sub-step 304-2, it may be determined, based on the remaining attribute values other than the attribute values of the at least one other attribute of the source database table based on which the determining in sub-steps 302-1 and 302-3 and the determining in sub-step 303-2 are performed, and the remaining attribute values other than the attribute values of the specific attribute of the target database table based on which the determining in sub-steps 302-1 and 302-3 and the determining in sub-step 303-2 are performed, whether the remaining attribute values comply with the determined data mapping relationship. For example, if the determining in the sub-steps 302-1 and 302-3 and the determining in the sub-step 303-2 are performed based on 99% attribute values of all the attribute values of the at least one other attribute of the source database table and 99% attribute values of all the attribute values of the specific value of the source database table, then in the sub-step 304-2, it may be determined, according to the remaining 1% of the attribute values of the at least one other attribute of the source database table and the remaining 1% of the attribute values of the specific attribute of the target database table, whether they comply with the determined data mapping relationship. Of course, new attribute values of the at least one other attribute may be obtained freshly from the source database table, and corresponding new attribute values of the specific attribute may be obtained freshly from the target database table, and in the sub-step 304-2, it may be determined whether the freshly obtained new attribute values and the corresponding attribute values comply with the determined data mapping relationship.

For the case where the determining in the above sub-steps 302-1 and 302-3 are performed based on the corresponding primary key value set corresponding to each attribute value of the specific attribute of the target database table and the primary key value set corresponding to each corresponding attribute value of the one or more other attributes of the source database table, and/or the case where the determining in the above sub-step 303-2 is performed based on the established corresponding relationship between each attribute value of the at least one other attribute of the source database table and each corresponding attribute value of the specific attribute of the target database table, new attribute values of the at least one other attribute may be obtained from the source database table, and new corresponding attribute values of the specific attribute may be obtained from the target database table again, and in sub-step 304-2, it may be determined whether the obtained new attribute values and the corresponding attribute values comply with the determined data mapping relationship.

According to an embodiment of the present invention, the apparatus of the present invention may automatically determine whether the specific attribute value of at least one other attribute of the at least one source database table and the corresponding attribute value of the specific attribute of the target database table comply with the determined data mapping relationship, and when it determines that the specific attribute value of the at least one other attribute of the at least one source database table and the corresponding attribute values of the specific attribute of the target database table do not comply with the determined data mapping relationship, it may present the specific attribute value of the at least one other attribute of the at least one source database table and the corresponding attribute value of the specific attribute of the target database table to the user so that the user can make further determination and processing, or present an error indication to the user.

Additional sub-step 3 (304-3): determine whether a specific attribute value of the at least one other attribute of the at least one source database table has a corresponding attribute value of the specific attribute of the target database table. If the specific attribute value of the at least one other attribute of the at least one source database table has a corresponding attribute value of the specific attribute of the target database table, this indicates that the specific attribute value of the at least one other attribute of the at least one source database table is not an orphaned value. If the specific attribute value of the at least one other attribute of the at least one source database table does not have a corresponding value of the specific attribute of the target database table, this indicates that the specific attribute value of the at least one other attribute of the at last one source database table is an orphaned value. At this time, the user may further determine according to the design speciation that whether this is caused by the application of filter logic in the design specification; if it is determined that this is not caused by the application of the filter logic in the design specification, the user may determine that there is a data error.

For the case where the determining in the above sub-steps 302-1 and 302-3 are performed based on the primary key value sets corresponding to attribute values exceeding a specified threshold percentage in all the attribute values of the one or more other attributes of the source database table, in a sub-step 304-3, it may be determined, with respect to the remaining attribute values other than the attribute values of the at least one other attribute of the source database table based on which the determining in sub-steps 302-1 and 302-3 is performed, whether the remaining attribute values have corresponding attribute values of the specific attribute of the target database table. In such a case, the sub-step 304-3 may be executed at the same time of the execution of sub-step 302-1 or 302-3. That is to say, at the same time of determining whether corresponding primary key value sets corresponding to the attribute values of the specific attribute value of the target database table is correspondent with the primary key value sets corresponding to the attribute values of the at least one other attribute of the source database table, it may be determined whether a specific attribute value of the at least one other attribute of the at least one source database table has a corresponding attribute value of the specific attribute of the target database table, i.e., determining whether the specific attribute value of the at least one other attribute of the at least one source database table is an orphaned value, and if it is an orphaned value, further determining whether the orphaned value is caused by the application of a filter logic in conformity with the design specification.

According to an embodiment of the present invention, the apparatus of the present invention can automatically determine whether a specific attribute value of the at least one other attribute of the at least one source database table has a corresponding attribute value of the specific attribute of the target database table, and when it determines that the specific attribute value of the at least one other attribute of the at least one source database table does not have a corresponding attribute value of the specific attribute of the target database table, it can present the specific attribute value of the at least one other attribute of the at least one source database table to the user, so that the user can further determine according to the design specification whether this is caused by the application of a filter logic in the design specification.

Additional sub-step 4 (304-4): determine whether a specific attribute value of the specific attribute of the target database table has a corresponding attribute value of the at least one other attribute of the at least one source database table. If the specific attribute value of the specific attribute of the target database table has a corresponding attribute value of the at least one other attribute of the at least one source database table, this indicates that the specific attribute value of the specific attribute of the target database table is not an orphaned value. If the specific attribute value of the specific attribute of the target database table does have a corresponding attribute value of the at least one other attribute of the at least one source database table, this indicates that the specific attribute value of the specific attribute of the target database is an orphaned value, at which time it usually can be determined that the orphaned value in the target database is dirty data generated during the ETL process, thus being a data error.

For the case where the determining in the above sub-steps 302-1 and 302-3 is performed based on the corresponding primary key value sets corresponding to attribute values exceeding a specified threshold percentage in all the attribute values of the specific attribute of the target database table, in the sub-step 304-4, it may be determined, with respect to the remaining attribute values other than the attribute values of the specific attribute of the target database table based on which the determining is performed in sub-step 302-1 and 302-3, whether the remaining attribute values have corresponding attribute values of the at least one other attribute of the source database table. In such a case, sub-step 304-4 may be executed during the execution of sub-step 302-1 or sub-step 302-3. That is to say, at the same time of determining whether the corresponding primary key value sets corresponding to the attribute values of the specific attribute of the target database are correspondent with the primary key value sets corresponding to the attribute values of the at least one other attribute of the source database table, it can be determined whether a specific attribute value of the specific attribute of the target database table has a corresponding specific attribute value of the at least one other attribute of the at least one source database table, i.e., determine whether the specific attribute value of the specific attribute of the target database table is an orphaned value or dirty data, and thus being a data error.

According to an embodiment of the present invention, the apparatus of the present invention can automatically determine whether a specific attribute value of the specific attribute of the target database table has a corresponding attribute value of the at least one other attribute of the at least one source database table, and when determining that the specific attribute value of the specific attribute of the target database table does not have a corresponding attribute value of the at least one other attributes of the at least one source database table, it presents the specific attribute value of the specific attribute of the target database table to the user for the user to perform further processing, or presents an error indication to the user.

Although in the above description a specific attribute in a target database table has been taken as an example to describe the method for validating data of the present invention, it is obvious to those skilled in the art that the method for validating data of the present invention can be applied to every attribute of plural target database tables one by one.

In addition, as those skilled in the art would appreciate, the term “database table” in the above description should be understood, in a broad sense, as any data structure that organizes data in the form of rows and columns and have a primary key.

Above is described a method for validating data according to embodiments of the present invention. It should be pointed out that the above description is only exemplary, rather than limiting the present invention. In other embodiments of the present invention, the method may have more, less or different steps, and the relationships like those of order and inclusion between the steps may be different from what is described.

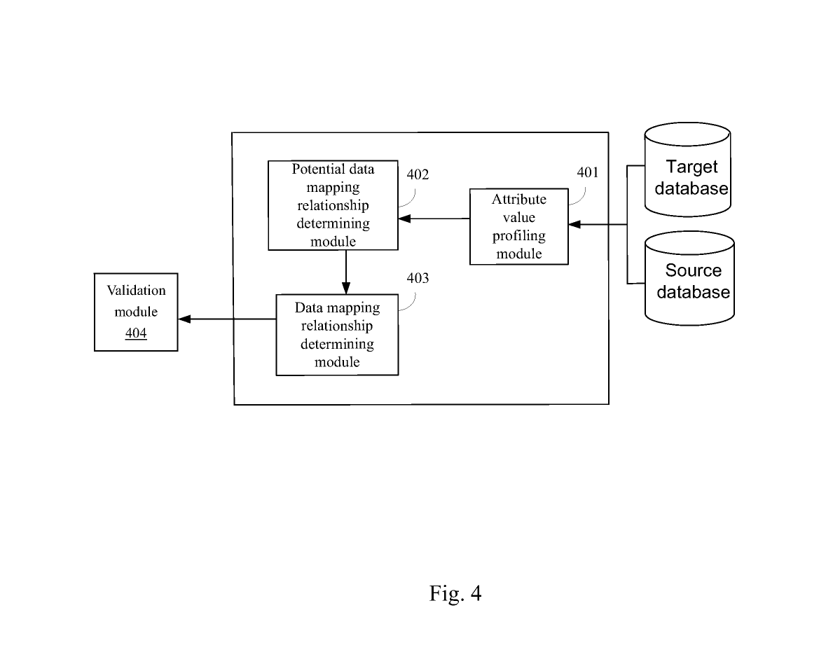

Now referring to FIG. 4, it shows an apparatus for determining a data mapping relationship between a source database table and a target database table according to an embodiment of the present invention. The apparatus may be used to execute the above method for determining a data mapping relationship between a source database table and a target database table according to an embodiment of the present invention; that is to say, the operations executed by the components of the apparatus are corresponding to the steps of the method. For simplicity, some details repeating with the above description is omitted in the following description, and thus the apparatus for determining a data mapping relationship between a source database table and a target database table according to an embodiment of the present invention can be understood in greater detail by referring to the above description.

As shown in FIG. 4, the apparatus for determining a data mapping relationship between a source database table and a target database table according to an embodiment of the present invention comprises: an attribute value profiling module 401 configured to obtain attribute values of at least one other attribute than a primary key and their corresponding primary key value sets from plural rows of data in a source database table, and obtain attribute values of a specific attribute other than a corresponding primary key and their corresponding primary key value sets from plural rows of data of the target database table; a potential data mapping relationship determining module 402 configured to determine whether the at least one other attribute of the at least one source database table and the specific attribute of the target database table have a potential data mapping relationship therebetween; a data mapping relationship determining module 403 configured to, if it is determined that the at least one other attribute of the at least one source databases table and the specific attribute of the target database table have a potential data mapping relationship therebetween, determine a data mapping relationship between the at least one other attribute of the at least one source database table and the specific attribute of the target database table.

According to an embodiment of the present invention, the potential data mapping relationship determining module 402 is further configured to determine whether the at least one other attribute of the source database table and the specific attribute of the target database table have a potential data mapping relationship therebetween by comparing the primary key value sets corresponding to the attribute values of the at least one other attribute of the at least one source database table and the corresponding primary key value sets corresponding to the attribute values of the specific attribute of the target database table.

According to a further embodiment of the present invention, the potential data mapping relationship determining module 402 is further configured to: determine whether the corresponding primary key value sets corresponding to the attribute values of the specific attribute of the target database table are correspondent with the primary key value sets corresponding to the attribute values of one other attribute of the at least one source database table; and, in response to the determination of yes, determine that the at least one other attribute of the at least one source database table and the specific attribute of the target database table have the potential data mapping relationship therebetween.

According to another embodiment of the present invention, the potential data mapping relationship determining module 402 is further configured to determine whether the corresponding primary key value sets corresponding to the attribute values of the specific attribute of the target database table are correspondent with the intersection of the primary key value sets corresponding to the attribute values of plural other attributes of the at least one source database table; and, in response to the determination of yes, determine that the plural other attributes of the at least one source database table and the specific attributes of the target database table have a potential data mapping relationship therebetween.

According to an embodiment, the potential data mapping relationship determining module 402 is further configured to determine whether the corresponding primary key value sets corresponding to the attribute values of the specific attribute of the target database table are correspondent with the primary key value sets corresponding to the attribute values of one other attribute of the at least one source database table, and whether the corresponding primary key value sets corresponding to the attribute values of the specific attribute of the target database table are correspondent with the intersection of the primary key value sets corresponding to the attribute values of plural other attributes of the at least one source database table, based on the corresponding primary key value sets corresponding to attribute values exceeding a specified threshold percentage among all the attribute values of the specific attribute of the target database table as well as the primary key value sets corresponding to attribute values exceeding a specified threshold percentage among all the attribute values of the one or more other attributes of the source database table.

According to an embodiment of the present invention, the data mapping relationship determining module 403 is further configured to: according to the corresponding relationships between the primary key value sets corresponding to the attribute values of the one or more other attributes of the at least one source database table and the corresponding primary key value sets corresponding to the attribute values of the specific attribute of the target database table, establish corresponding relationships between the attribute values of the one or more other attributes of the at least one source database table and the attribute values of the specific attribute of the target database table; and, according to the established corresponding relationships between the attribute values of the one or more other attributes of the at least one source database table and the attribute values of the specific attribute of the target database table, determine the data mapping relationship between the one or more other attributes of at least one source database table and the specific attribute of the target database table.

According to an embodiment of the present invention, the data mapping relationship determining module 403 is further configured to determine the data mapping relationship between the one or more other attributes of the source database table and the specific attribute of the target database table based on the established corresponding relationships between attribute values exceeding a specified threshold percentage among all the attribute values of the one or more other attributes in the source database table and corresponding attribute values exceeding a specified threshold percentage among all the attribute values of the specific attribute of the target database table.

According to an embodiment of the present invention, the potential data mapping relationship determining module 402 determines whether the at least one other attribute of the at least one source database table and the specific attribute of the target database table have a potential data mapping relationship therebetween, and the data mapping relationship determining module 403 determines the data mapping relationship between the at least one other attribute of the at least one source database table and the specific attribute of the target database table, based on a design specification including the data transformation relationship between the source database table and the target database table.

Above is described the apparatus for determining a data mapping relationship between a source database table and a target database table according to embodiments of the present invention. It should be pointed out that the above description is only exemplary, not limiting the present invention. In other embodiments of the present invention, the apparatus may have more, less or different components, and the relationships like those of connection, inclusion and function between the components may be different from that is illustrated and described.

In another aspect of the present invention, there is provided an apparatus for validating data. According to an embodiment of the present invention, the apparatus for validating data comprises the modules in the above apparatus for determining a data mapping relationship between a source database table and a target database table according to an embodiment of the present invention, and further comprises the following additional modules: a validation module 404 configured to validate attribute values of the at least one other attribute of the source database table and/or attribute values of the specific attribute of the target database table according to the determined data mapping relationship.

According to an embodiment of the present invention, the validation module comprises any one or more of: a design specification compliance determining module configured to determine whether the determined data mapping relationship complies with a design specification by comparing the determined data mapping relationship with the design specification; a data mapping relationship compliance determining module configured to determine whether a specific attribute value of the at least one other attribute of the source database table and a corresponding specific attribute value of the specific attribute of the target database table comply with the determined data mapping relationship; a source orphan determining module configured to determine whether a specific attribute value of the at least one other attribute of the at least one source database table has a corresponding attribute value of the specific attribute of the target database table; and a target orphan determining module configured to determine whether a specific attribute value of the specific attribute of the target database table has a corresponding attribute value of at least one other attribute of the at least one source database table.

According to an embodiment of the present invention, the target database table is a database table in a data warehouse in a business intelligence solution, and the at least one source database table is a database table in a business system database as the data of the data warehouse.

Above is described an apparatus for validating data according to embodiments of the present invention. It should be pointed out that the above description is only exemplary, not limiting the present invention. In other embodiments of the present invention, the apparatus may have more, different or less components, and the relationships like those of connection, inclusion and functions between the components may be different from that is described.

The present invention can be realized in hardware, software, or a combination thereof. The present invention can be realized in a computer system in a centralized manner, or in a distributed manner, in which, different components are distributed in some interconnected computer system. Any computer system or other devices suitable for executing the method described herein are appropriate. A typical combination of hardware and software can be a computer system with a computer program, which when being loaded and executed, controls the computer system to execute the method of the present invention, and constitutes the apparatus of the present invention.

The present invention can also be embodied in a computer program product, which can realize all the features of the method described herein, and when being loaded into a computer system, can execute the method.

Although the present invention has been illustrated and described with reference to the preferred embodiments, those skilled in the art will understand that various changes both in form and details may be made thereto without departing from the spirit and scope of the present invention.

1. A method for determining a data mapping relationship between a source database table and a target database table, comprising:
obtaining attribute values of at least one other attribute than a primary key and corresponding primary key value sets from plural rows of data in at least one source database table, and obtaining attribute values of a specific attribute other than a corresponding primary key and corresponding primary key value sets from plural rows of data in the target database table;
determining whether the at least one other attribute of the at least one source database table and the specific attribute of the target database table have a potential data mapping relationship therebetween;
if it is determined that the at least one other attribute of the at least one source database table and the specific attribute of the target database table have a potential data mapping relationship therebetween, determining a data mapping relationship between the at least one other attribute of the at least one source database table and the specific attribute of the target database table.

2. The method of claim 1, wherein determining whether the at least one other attribute of the at least one source database table and the specific attribute of the target database table have a potential data mapping relationship therebetween is performed by comparing the primary key value sets corresponding to the attribute values of the at least one other attribute of the at least one source database table and the primary key value sets corresponding to the attribute values of the specific attribute of the target database table.

3. The method of claim 2, wherein determining whether the at least one other attribute of the at least one source database table and the specific attribute of the target database table have a potential data mapping relationship therebetween comprising:
determining whether the corresponding primary key value sets corresponding to the attribute values of the specific attribute of the target database table are correspondent with the primary key value sets corresponding to the attribute values of one other attribute of the at least one source database table; and
in response to a determination of yes, determining that the one other attribute of the at least one source database table and the specific attribute of the target database table have a potential data mapping relationship therebetween.

4. The method of claim 2, wherein determining whether the at least one other attribute of the at least one source database table and the specific attribute of the target database table have a potential database mapping relationship therebetween comprises:
determining whether the corresponding primary key value sets corresponding to the attribute values of the specific attribute of the target database table are correspondent with the intersection of the primary key value sets corresponding to the attribute values of plural other attribute of the at least one source database table;
in response to a determination of yes, determining that the plural other attributes of the at least one source database table and the specific attribute of the target database table have a potential data mapping relationship therebetween.

5. The method of claim 1, wherein determining a data mapping relationship between the at least one other attribute of the at least one source database table and the specific attribute of the target database table comprises:
according to the corresponding relationships between the primary key value sets corresponding to the attribute values of the at least one other attribute of the at least one source database table and the corresponding primary key value sets corresponding to the attribute values of the specific attribute of the target database table, establishing the corresponding relationships between the attribute values of the at least one other attribute of the at least one source database table and the attribute values of the specific attribute of the target database table; and
according to the established corresponding relationships between the attribute values of the at least one other attribute of the at least one source database table and the attribute values of the specific attribute of the target database table, determining a data mapping relationship between the at least one other attribute of the at least one source database table and the specific attribute of the target database table.

6. The method of claim 5, wherein determining a data mapping relationship between the at least one other attribute of the source database table and the specific attribute of the target database table is performed based on the corresponding relationships between attribute values exceeding a specified threshold percentage among all the attribute values of the at least one other attribute of the source database table and corresponding attribute values exceeding a specified threshold percentage among all the attribute values of the specific attribute of the target database table.

7. The method of claim 1, wherein determining whether the at least one other attribute of the at least one source database table and the specific attribute of the target database table have a potential database table and determining a data mapping relationship between the at least one other attribute of the at least one source database table and the specific attribute of the target database table are performed based on a design specification including a data transformation relationship between the source database table and the target database table.

8. The method of claim 1, wherein the target database table is a database table in a data warehouse in a business intelligence solution, and the at least one source database table is a database table in a business system database as a data source of the data warehouse.

9. A method for validating data as recited in claim 1, further comprising:
validating attribute values of at least one other attribute of the at least one source database table and/or attribute values of the specific attribute of the target database table according to the determined data mapping relationship.

10. The method of claim 9, wherein validating attribute values of at least one other attribute of the at least one source database table and/or attribute values of the specific attribute of the target database table according to the determined data mapping relationship comprises any one or more of the following:
determining whether the determined data mapping relationship complies with a design specification including the data conversion relationship between the source database table and the target database table by comparing the determined data mapping relationship with the design specification;
determining whether a specific attribute value of the at least one other attribute of the at least one source database table and a corresponding attribute value of the specific attribute of the target database table comply with the determined data mapping relationship;
determining whether a specific attribute value of the at least one other attribute of the at least one source database table has a corresponding attribute value of the specific attribute of the target database table;
determining whether a specific attribute value of the specific attribute of the target database table has a corresponding attribute value of the at least one other attribute of the at least one source database table.

11. An apparatus for determining a data mapping relationship between a source database table and a target database table, comprising:
an attribute value profiling module configured to obtain attribute values of at least one other attribute than a primary key and corresponding primary key value sets from plural rows of data in at least one source database table, and obtaining attribute values of a specific attribute other than a corresponding primary key and corresponding primary key value sets from plural rows of data in the target database table;
a potential data mapping relationship determining module configured to determine whether the at least one other attribute of the at least one source database table and the specific attribute of the target database table have a potential data mapping relationship therebetween;
a data mapping relationship determining module configured to, if it is determined that the at least one other attribute of the at least one source database table and the specific attribute of the target database table have a potential data mapping relationship therebetween, determine the data mapping relationship between the at least one other attribute of the at least one source database table and the specific attribute of the target database table.

12. The apparatus of claim 11, wherein the potential data mapping relationship determining module is further configured to determine whether the at least one other attribute of the at least one source database table and the specific attribute of the target database table have a potential data mapping relationship therebetween by comparing the primary key value sets corresponding to the attribute values of the at least one other attribute of the at least one source database table and the primary key value sets corresponding to the attribute values of the specific attribute of the target database table.

13. The apparatus of claim 12, wherein the potential mapping relationship determining module is further configured to:
determine whether the corresponding primary key value sets corresponding to the attribute values of the specific attribute of the target database table are correspondent with the primary key value sets corresponding to the attribute values of one other attribute of the at least one source database table; and
in response to a determination of yes, determine that the one other attribute of the at least one source database table and the specific attribute of the target database have a potential data mapping relationship therebetween.

14. The apparatus of claim 12, wherein the potential data mapping relationship determining module is further configured to:
determine whether the corresponding primary key value sets corresponding to the attribute values of the specific attribute of the target database table are correspondent with the intersection of the primary key value sets corresponding to the attribute values of plural other attributes of the at least one source database table; and
in response to a determination of yes, determine that the plural other attributes of the at least one source database table and the specific attribute of the target database table have a potential data mapping relationship therebetween.

15. The apparatus of claim 11, wherein the data mapping relationship determining module is further configured to:
according to the corresponding relationships between the primary key value sets corresponding to the attribute values of the one or more other attributes of the at least one source database table and the corresponding primary key value sets corresponding to the attribute values of the specific attribute of the target database table, establish the corresponding relationships between the attribute values of the one or more other attributes of the at least one source database table and the attribute values of the specific attribute of the target database table; and
according to the established corresponding relationships between the attribute values of the one or more other attributes of the at least one source database table and the attribute values of the specific attribute of the target database table, determine the data mapping relationship between one or more other attributes of the at least one source database table and the specific attribute of the target database table.

16. The apparatus of claim 15, wherein the data mapping relationship determining module is further configured to determine the data mapping relationship between the one or more other attributes of the source database table and the specific attribute of the target database table based on the established corresponding relationships between attribute values exceeding a specified threshold percentage among all the attribute values of the one or more other attributes of the source database table and corresponding attribute values exceeding a specified threshold percentage among all the attribute values of the specific attribute of the target database table.

17. The apparatus of claim 11, wherein the potential data mapping relationship determining module is further configured to determine whether the at least one other attribute of the at least one source database table and the specific attribute of the target database table have a potential data mapping relationship therebetween, and the data mapping relationship determining module determines the data mapping relationship between the at least one other attribute of the at least one source database table and the specific attribute of the target database table, based on a design specification including a data transformation relationship between the source database table and the target database table.

18. The apparatus of claim 11, wherein the target database table is a database table in a data warehouse in a business intelligence solution, and the at least one source database table is a database table in a business system database as a data source of the data warehouse.

19. An apparatus for validating data as recited in claim 11, further comprising:
a validation module configured to, according to the determined data mapping relationship, validate attribute values of the at least one other attribute of the at least one source database table and/or attribute values of the specific attribute of the target database table.

20. The apparatus of claim 19, wherein the validation module comprises any one or more of:
a design specification compliance determining module configured to determine whether the determined data mapping relationship complies with a design specification including a data transformation relationship between the source database table and the target database table by comparing the determined data mapping relationship with the design specification;
a data mapping relationship compliance determining module configured to determine whether a specific attribute value of the at least one other attribute of the at least one source database table and a corresponding attribute value of the specific attribute of the target database table comply with the determined data mapping relationship;
a source orphan determining module configured to determine whether a specific attribute value of the at least one other attribute of the at least one source database table has a corresponding attribute value of the specific attribute of the target database table; and
a target orphan value determining module configured to determine whether a specific attribute value of the specific attribute of the target database table has a corresponding attribute value of the at least one other attribute of the at least one source database table.
